(19) United States
(12) Patent Application Publication
(10) Pub. No.: US 2005/0057176 A1
(43) Pub. Date: Mar. 17, 2005

(54) Color tunable panel of organic electroluminscent display

(75) Inventors: Tien-Rong Lu, Tainan City (TW); Yih Chang, Jhonghe City (TW)

Correspondence Address: BIRCH STEWART KOLASCH & BIRCH, PO BOX 747, FALLS CHURCH, VA, 22040-0747, US

(73) Assignee: RITDISPLAY CORPORATION, Taiwan (TW)

(21) Appl. No.: 10/921,826

(22) Filed: Aug. 20, 2004

(30) Foreign Application Priority Data
Aug. 21, 2003 (TW) 092123080
Aug. 21, 2003 (TW) 092123081

(51) Int. Cl. G09G 3/10

(52) U.S. Cl. 315/169.3

(57) ABSTRACT

A color tunable panel of an organic electroluminescent display at least comprises a transparent substrate, an organic light-emitting area and a micro-lens array. The transparent substrate has a first surface and a second surface opposite to the first surface. The organic light-emitting area is disposed over the first surface of the transparent substrate and comprises a plurality of pixels for emitting white light or short-wavelength light. The micro-lens array is disposed over the second surface of the transparent substrate and comprises a plurality of micro-lenses doped with a fluorescent material and/or a phosphorescent material.

### BACKGROUND OF THE INVENTION

1. Field of Invention

The invention relates to a color tunable panel and, in particular, to a color tunable panel of an organic electroluminescent display.

2. Related Art

The full-color technologies utilized in the present organic electroluminescent displays mainly include the following three. The first technology is “Three Primary Colors Light-emitting Method” that uses respectively three primary colors (Red, Green, and Blue) for independent electroluminescent units. The second technology is “Color Conversion Medium (CCM)” that includes a blue CCM and cooperates with a red CCM and a green CCM to generate various colors. The third technology is “Color Filter Method” that includes white light electroluminescent layer and color filters. Hereinafter, the CCM technology is taken for an example and is described below.

Idemitsu Kosan Co. is one of the leaders in developing the CCM technology. As shown in FIG. 1, a color display panel 5 comprises an organic light-emitting area 51, a planarization layer 52, a color conversion layer 53, and a glass substrate 54. The organic light-emitting area 51 is disposed on the planarization layer 52, the planarization layer 52 is disposed on the color conversion layer 53, and the color conversion layer 53 is disposed on the glass substrate 54. In this case, the organic light-emitting area 51 includes a first electrode 511, an organic functional layer 512 and a second electrode 513, which are disposed on the planarization layer 52 in sequence. The organic functional layer 512 is made of a white light material, so that the organic light-emitting area 51 can emit white light. The color conversion layer 53 comprises a plurality of blue filters 531, green filters 532, red filters 533, blue conversion films 531′, green conversion films 532′ and red conversion films 533′. The blue conversion films 531′, the green conversion films 532′ and the red conversion films 533′ are disposed on the blue filters 531, the green filters 532 and the red filters 533, respectively. The filters 531, 532, and 533 are corresponding to the pixels of the organic light-emitting area 51, respectively.

The white light emitted from the organic light-emitting area 51 can pass through the blue conversion film 531′, green conversion film 532′ and red conversion film 533′, and converted into blue light, green light and red light, respectively. The blue light, green light and red light converted from the white light pass the blue filter 531, the green filter 532 and the red filter 533 respectively, to increase the contrast of the blue color, the green color and the red color. Finally, a driving circuit is provided to produce the desired color screen according to the generated three primary colors (red color (R), green color (G), and blue color (B)).

In the conventional color display panel 5, however, since at least three photolithography processes are necessary to form the blue conversion films 531′, the green conversion films 532′ and the red conversion films 533′ on the blue filters 531, the green filters 532 and the red filters 533, the manufacturing processes of the color display panel 5 are more complex and the cost thereof is increased. Furthermore, since the color display panel 5 includes the planarization layer 52 to make the whole panel more planar, the thickness of the whole panel 5 is also increased, which did not follow the trend toward lightweight and compact devices.

In addition, the light generated from inside of the organic electroluminescent display panel may get lose a lot during the transmission to the outside, which decreases the external quantum efficiency of the display panel.

To solve this problem, a convex lens is additionally attached to the light-emitting surface of the substrate with higher refraction so as to enhance the external quantum efficiency. As shown in FIG. 2, a convex lens 61, which has the diameter of 2 mm to 3 mm, is attached to the light-emitting surface of the element. If the convex lens 61 and the substrate 62 are made of the same material, the light flux thereof may increase 0.6 to 1 time. If the convex lens 61 has higher refraction, the light reflux thereof may increase 2 times. Herein, the refraction index matching oil is used to attach the lens to the light-emitting surface of the element, which limits the lifetime of the element.

However, the previously mentioned lens has too large diameter and thickness (several millimeters), so the whole device has too large dimension, which does not match the trend toward lightweight and compact light-emitting devices. Furthermore, since the refraction index matching oil is used to attach to lens to the light-emitting surface of the element, the lens may be stripped off easily. Thus, the lifetime of the device is short.

It is therefore a subjective of the invention is to provide a color tunable panel of an organic electroluminescent display, which can solve the above-mentioned problems.

### SUMMARY OF THE INVENTION

In view of the foregoing, the invention is to provide a color tunable panel of an organic electroluminescent display, which can modulate the light color and increase the luminescent efficiency.

To achieve the above, a color tunable panel of an organic electroluminescent display of the invention at least comprises a transparent substrate, an organic light-emitting area and a micro-lens array. In the invention, the transparent substrate has a first surface and a second surface, which are opposite to one another. The organic light-emitting area is disposed over the first surface of the transparent substrate and comprises a plurality of pixels for emitting white light or short-wavelength light. The micro-lens array is disposed over the second surface of the transparent substrate and comprises a plurality of micro-lenses doped with a fluorescent material and/or a phosphorescent material.

To achieve the above, another color tunable panel of an organic electroluminescent display of the invention at least comprises a transparent substrate, an organic light-emitting area and a film of a micro-lens array. In the invention, the transparent substrate has a first surface and a second surface, which are opposite to one another. The organic light-emitting area is disposed over the first surface of the transparent substrate and comprises a plurality of pixels for emitting white light and short-wavelength light. The film of a micro-lens array is disposed over the second surface of the transparent substrate and comprises a plurality of micro-lenses doped with a fluorescent material and/or a phosphorescent material.

As mentioned above, the color tunable panel of the organic electroluminescent display comprises the micro-lenses doped with the fluorescent materials and/or the phosphorescent materials, the micro-lens array or the film of a micro-lens array, which are disposed over the second surface of the transparent substrate. Comparing with the conventional art, the micro-lenses doped with the fluorescent materials and/or the phosphorescent materials, the micro-lens array or the film of a micro-lens array can convert the white light or short-wavelength light, such as UV light or blue light, emitted from the organic light-emitting area into monochromatic light of various colors, combination of monochromatic lights, or broadband spectrum white light. Thus, the color tunable panel for emitting monochromatic light, combination of monochromatic lights, white light or color light can be obtained. Furthermore, the luminescent efficiency of the panel can be increased by the excitation of short-wavelength light to the fluorescent materials and/or the phosphorescent materials, so the decay of luminescent efficiency caused by the absorption of the color conversion films and filters in the color conversion medium technology can be compensated efficiently. Moreover, the invention comprises color filters to purify each color light or to filter out the wanted color light, so that the application of the display on the various colors can be broadened. In addition, the micro-lenses doped with the fluorescent materials and/or the phosphorescent materials and the film of a micro-lens array can improve the color purity of the white light emitted from the organic light-emitting area. This can provide a uniform and broadband radiation spectrum to satisfy the application of full color displays. The special shape of the micro-lenses can decrease the possibility that the light is restricted inside the panel, so as to increase the external quantum efficiency of the organic electroluminescent display. The micro-lenses can also protect the substrate from scratch. The micro-lenses can be manufactured by screen printing, ink-jet printing or semiconductor processes and the film of a micro-lens array can be manufactured by ejection modeling or thermal-pressing formation, which are simple, convenient operation, and low manufacturing cost. Thus, the invention is suitable for mass production. Furthermore, the invention comprises an isolating layer for controlling the moving direction of the light emitted from the micro-lenses, so that the light scattering and interfering can be reduced. In brief, micro-lenses doped with fluorescent material and/or phosphorescent material and the film of a micro-lens array of the invention possesses the function of modulating colors emitted form the panel, pixel protection. Also, the micro-lenses with high refraction can compensate the luminescent efficiency lose after filtering, and further increase luminescent efficiency. Therefore, the display of the invention can provide a uniform spectrum, increase the aspect ratio of the pixels when the panel emits light, and increase the lifetime thereof. In addition, when the color tunable panel of the organic electroluminescent display can display full color, the conventional selective deposition processes for forming the three primary color pixels can be saved. Thus, the resolution of the panel may not restrict to the fine pattern of the mask, and the manufacturing yield can be enhanced. Therefore, the invention can apply the present developed fluorescent and/or phosphorescent materials and color filter technology in the panel, so as to speed the commercialization of color tunable panel of the organic electroluminescent display.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing the conventional full color display panel;

FIG. 2 is a schematic view showing the conventional color display panel;

FIGS. 3A and 3B are schematic views showing a color tunable panel of an organic electroluminescent display according to a first embodiment of the invention;

FIGS. 4A, 4B, and 4C are schematic views showing micro-lenses according to the first embodiment of the invention;

FIG. 5 is a schematic view showing a color tunable panel of an organic electroluminescent display according to a second embodiment of the invention;

FIG. 6 is a schematic view showing a color tunable panel of an organic electroluminescent display according to a third embodiment of the invention;

FIG. 7 is a schematic view showing a color tunable panel of an organic electroluminescent display according to a fourth embodiment of the invention;

FIG. 8 is a schematic view showing a color tunable panel of an organic electroluminescent display according to a fifth embodiment of the invention;

FIG. 9 is a schematic view showing a color tunable panel of an organic electroluminescent display according to a sixth embodiment of the invention;

FIG. 10 is a schematic view showing a color tunable panel of an organic electroluminescent display according to a seventh embodiment of the invention; and

FIG. 11 is a schematic view showing a color tunable panel of an organic electroluminescent display according to an eighth embodiment of the invention.

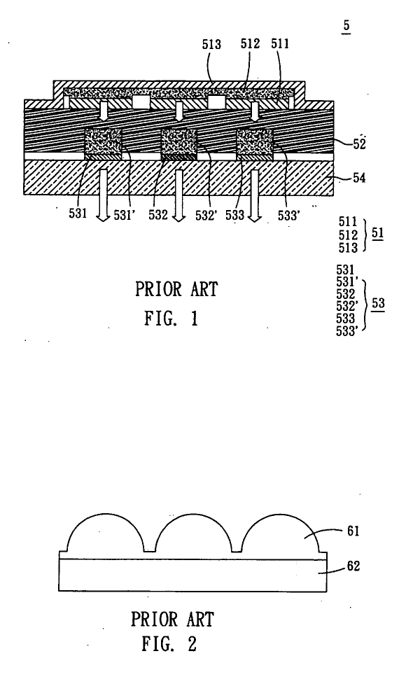

### DETAILED DESCRIPTION OF THE INVENTION

The present invention will be apparent from the following detailed description, which proceeds with reference to the accompanying drawings, wherein the same references relate to the same elements.

First Embodment

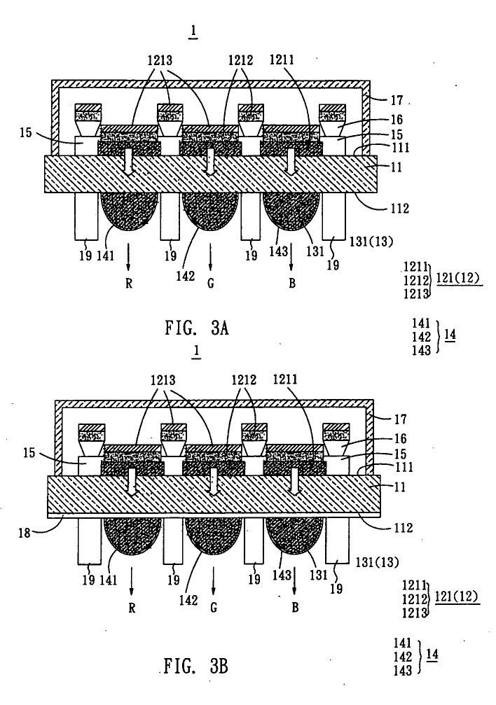

With reference to FIGS. 3A and 3B, a color tunable panel of an organic electroluminescent display 1 at least comprises a transparent substrate 11, an organic light-emitting area 12 and a micro-lens array 13. In the embodiment, the transparent substrate 11 has a first surface 111 and a second surface 112, which are opposite to one another. The organic light-emitting area 12 is disposed on the first surface 111 of the transparent substrate 11. The organic light-emitting area 12 comprises a plurality of pixels 121 for emitting white light. The micro-lens array 13 is disposed on the second surface 112 of the transparent substrate 11 and comprises a plurality of micro-lenses 131 doped with a fluorescent material and/or a phosphorescent material.

In the present embodiment, the transparent substrate 11 can be a flexible or a rigid substrate. The transparent substrate 11 can also be a plastic or glass substrate. In particular, the flexible substrate or plastic substrate can be made of polycarbonate (PC), polyester (PET), cyclic olefin copolymer (COC), or metallocene-based cyclic olefin copolymer (mCOC). Of course, the transparent substrate 11 can be a silicon substrate.

Referring to FIGS. 3A and 3B, the organic light-emitting area 12 is disposed on the first surface 111 of the transparent substrate 11 and comprises a plurality of pixels 121 for emitting white light. Herein, each pixel 121 comprises a first electrode 1211, at least one organic functional layer 1212 and a second electrode 1213.

The first electrode 1211 is formed on the transparent substrate 11 by a sputtering method or an ion plating method. The first electrode 1211 is usually used as an anode and made of a transparent conductive metal oxide, such as indium-tin oxide (ITO), aluminum-zinc oxide (AZO), or indium-zinc oxide (IZO).

The organic functional layer 1212 in the current embodiment is disposed on the first electrode 1211. The organic functional layer 1212 usually comprises a hole injection layer, a hole transporting layer, an electroluminescent layer, an electron transporting layer and an electron injection layer (not shown). The hole injection layer comprises copper phthalocyanine (CuPc), the hole transporting layer comprises 4,4′-bis[N-(1-naphthyl)-N-phenylamino]biphenyl (NPB), the electron injection layer comprises lithium fluoride (LiF), and the electron transporting layer comprises tris(8-quinolinato-N1,08)-aluminum (Alq). Each layer of the organic functional layer 1212 may be formed upon the first electrode 1211 by utilizing evaporation, spin coating, ink jet printing, or printing. Herein, the light emitted from the organic functional layer 1212 is broadband white light. This may be carried out by mixing electroluminescent materials with complementary colors such as orange and blue. Of course, electroluminescent materials with other complementary colors could be used.

The second electrode 1213 is disposed on the organic functional layer 1212. Herein, the second electrode 1213 can be formed on the organic functional layer 1212 by way of evaporation or sputtering. The material of the second electrode 1213 can be, for example but not limited to, aluminum, calcium, magnesium, indium, zinc, manganese, silver, gold, and magnesium alloy. The magnesium alloy can be, for example but not limited to, Mg:Ag alloy, Mg:In alloy, Mg:Sn alloy, Mg:Sb alloy and Mg:Te alloy.

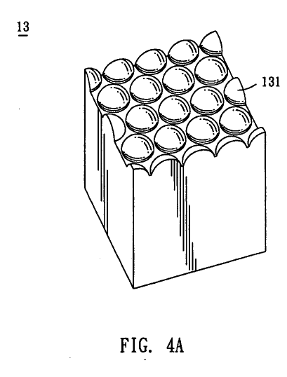

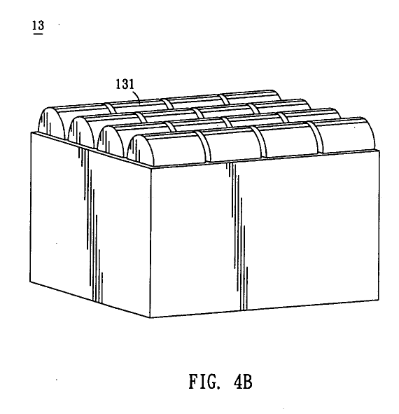

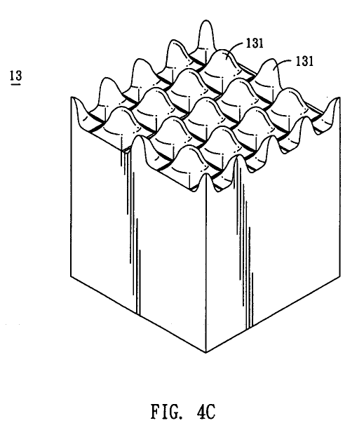

With reference to FIGS. 3A and 3B again, the micro-lens array 13 is disposed on the second surface 112 of the transparent substrate 11 and comprises a plurality of micro-lenses 131 corresponding to the pixels 121, respectively. Each of the micro-lenses 131 of the embodiment has a curved surface, and the curved surfaces of the micro-lenses 131 are partial spherical as shown in FIG. 4A. Of course, the curved surfaces of the micro-lenses 131 can be partial cylindrical as shown in FIG. 4B. Each of the micro-lenses 131 can be a convex curved surface having a regular polygon boundary, such as a convex curved surface having a square boundary as shown in FIG. 4C.

In the embodiment, the micro-lenses 131 are capable of improving the external quantum efficiency of the color tunable panel 1. In the color tunable panel 1, the light emitted from the organic light-emitting area 12 may be totally reflected inside the panel to cause the panel waveguide phenomenon. Thus, the micro-lenses 131 can focus the light, which has an incident angle larger than the critical angle thereof, and then pass it out of the panel. Accordingly, the external quantum efficiency of the color tunable panel 1 can be greatly increased.

In this embodiment, the micro-lenses 131 can be a transparent medium doped with a fluorescent material and/or a phosphorescent material. Herein, the material of the protecting medium can be at least one selected from, and is not limited to, the group consisting of Polymethyl methacrylate (PMMA), tetrafluoroethylene resine, silicon resin and silicon dioxide. The transparent medium of the embodiment can be made of photo-cured material, which can be cured by ultraviolet light. In addition, the transparent medium has high refraction for increasing the external quantum efficiency. The transparent medium of the embodiment is capable of adhesive and/or waterproof.

In the embodiment, the micro-lenses 131 can be formed by screen printing, ink-jet printing or semiconductor processes, and the formed micro-lenses 131 of these methods have higher curvature radiuses.

In addition, the micro-lenses 131 may be doped with a fluorescent material and/or a phosphorescent material. As shown in FIGS. 3A and 3B, the fluorescent material can be red fluorescent powder, green fluorescent powder or blue fluorescent powder, and the phosphorescent material can be red phosphorescent powder, green phosphorescent powder or blue phosphorescent powder.

As mentioned above, the fluorescent material may include more than one organic dyes or more than one inorganic dyes. Herein, the red fluorescent powder may be an azo dye (organic dye) or Y₂O₂S:Eu³⁺, Bi³⁺ (inorganic dye). The green fluorescent powder may be a CuPc dye (organic dye) or SrGa₂O₄:Eu²⁺ (inorganic dye). The blue fluorescent powder may be a cyanine dye (organic dye) or SrGa₂S₄:Eu²⁺ (inorganic dye). In this embodiment, the fluorescent material may be nano sized powder.

In addition, the phosphorescent material may include more than one organic dye or more than one inorganic dye. In the embodiment, the red phosphorescent powder may be 2,3,7,8,12,13,17,18-octaethyl-12H,23H-porphine platinum(II) [PtOEP] or Tris-(4,4,4-trifluoro-1-(2-thienyl)-1,3-butanediono)-1,10-phenanthroline europium(III) [Eu(TTA)3phen]. The green phosphorescent powder may be Bis(2-phenyl-pyridinato-N,C2)iridium(acetylacetone) [ppy2Ir(acac)] or Iridium(III)bis(tolypyridine)salicyclidene [tpyIrsd]. The blue phosphorescent powder may be Iridium-bis(4,6-di-fluorophenyl-pyridinato-N,C2)-picolinate [Firpic] or Bis[(4,6-difluorophenyl-pyridinato-N,C2)iridium(acetylacetone) [Fir(acac)]. In this embodiment, the phosphorescent material may be nano sized powder.

Referring to FIGS. 3A and 3B, the color tunable panel 1 further comprises a plurality of filters 14 disposed on the micro-lenses 131. In the current embodiment, the filters 14 comprise at least one red filter 141, at least one green filter 142 and at least one blue filter 143.

In the embodiment, the white light emitted from the organic light-emitting area 12 passes the micro-lens doped with red fluorescent powder and/or red phosphorescent powder, the micro-lens doped with green fluorescent powder and/or green phosphorescent powder, and the micro-lens doped with blue fluorescent powder and/or blue phosphorescent powder, respectively, so as to generate red light, green light and blue light. The generated red light, green light and blue light then respectively pass through the red filter 141, the green filter 142 and the blue filter 143 to generate the red light, green light and blue light of high purity. As shown in FIGS. 3A and 3B, the full color display panel can be obtained.

With reference to FIGS. 3A and 3B, the color tunable panel 1 of the embodiment further comprises a pixel defining layer 15, which is disposed on the first electrode 1211 and/or the transparent substrate 11 for defining the pixels 121 of the organic light-emitting area 12. The pixel defining layer 15 may also possess the effects of black shielding or light reflecting, so that the light from the pixels 121 can be prevented from mixing light. Accordingly, the direction of the emitted light can be controlled, and the usage and uniformity of the light can be increased.

As shown in FIGS. 3A and 3B, the color tunable panel 1 of the embodiment further comprises a separating layer 16, which is disposed on the pixel defining layer 15, for separating the individual pixel 121 of the organic light-emitting area 12. Herein, the separating layer 16 is made of insulating materials and has a top width larger than the bottom width thereof.

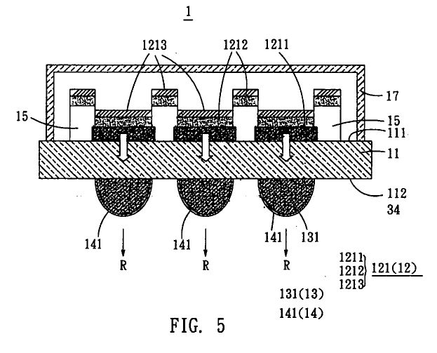

The separating layer 16 is configured in a Passive Matrix OLED (PMOLED) for simply separating the cathodes of the pixels 121. Alternatively, in an Active Matrix OLED (AMOLED) as shown in FIG. 5, since the pixels 121 are controlled by thin-film transistors, the separating layer 16 is unnecessary.

The color tunable panel 1 of the embodiment may further comprise a driving circuit (not shown), which is passive driving circuit or active driving circuit and is connected to the organic light-emitting area 12 and power source (not shown). Herein, the driving circuit can control the on/off and brightness of each pixel 121 of the organic light-emitting area 12.

Furthermore, the color tunable panel 1 of the embodiment may further comprise an encapsulating unit 17, such as a cover plate. In the embodiment, the encapsulating unit 17 is attached to the transparent substrate 11 with an adhesive. Thus, the encapsulating unit 17 can prevent the pixels 121 (the organic functional layer 1212) from invasion of water and oxygen. Of course, the encapsulating unit 17 can also be a passivation film (not shown).

As shown in FIG. 3B, a medium layer 18 is further disposed between the micro-lens array 13 and the second surface 112 of the transparent substrate 11. The micro-lenses 131 doped with the fluorescent material and/or the phosphorescent material is disposed on the medium layer 18.

In addition, as shown in FIGS. 3A and 3B, the color tunable panel 1 of the embodiment may further comprise an isolating layer 19, which is disposed on the second surface 112 of the transparent substrate 11 for isolating the micro-lenses 131. This configuration can control the moving direction of the emitted light.

Second Embodiment

With reference to FIG. 5, the micro-lenses 131 are doped with a fluorescent material and/or a phosphorescent material. Wherein, the fluorescent material is red fluorescent powder, and the phosphorescent material is red phosphorescent powder. In the second embodiment, the white light emitted from the organic light-emitting area 12 passes through the micro-lenses 131 doped with the red fluorescent powder and/or red phosphorescent powder, so as to generate red light. Herein, the color tunable panel 1 is a red light display panel.

In this embodiment, the color tunable panel 1 may also comprise a plurality of filters 14. Herein, the filters 14 are red filters 141.

Of course, the fluorescent material can be green fluorescent powder, the phosphorescent material can be green phosphorescent powder, and the filters 14 can be green filters 142. Herein, the color tunable panel 1 is a green light display panel (not shown).

Of course, the fluorescent material can be blue fluorescent powder, the phosphorescent material can be blue phosphorescent powder, and the filters 14 can be blue filters 143. Herein, the color tunable panel 1 is a blue light display panel (not shown).

Moreover, the fluorescent material and/or the phosphorescent material can be the fluorescent material and/or the phosphorescent material for emitting other monochromatic light, so as to manufacture the display panel with other monochromatic light.

Third Embodiment

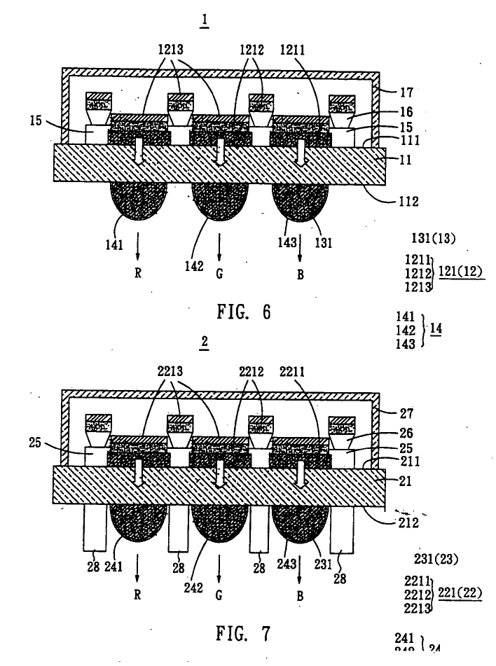

With reference to FIG. 6, the fluorescent material can be the mixture of red fluorescent powder, green fluorescent powder and blue fluorescent powder, and the phosphorescent material can be the mixture of red phosphorescent powder, green phosphorescent powder and blue phosphorescent powder.

In the embodiment, the white light emitted from the organic light-emitting area 12 passes through the micro-lenses 131 doped with the mixture of the red fluorescent powder, green fluorescent powder and blue fluorescent powder, and/or the mixture of the red phosphorescent powder, green phosphorescent powder and blue phosphorescent powder so as to generate broadband spectrum white light. Herein, the color tunable panel 1 is a white light display panel.

In this embodiment, the color tunable panel 1 may also comprise a plurality of filters 14. Herein, the filters 14 are red filters 141, green filters 142 and blue filters 143. The broadband spectrum white light formed by the micro-lenses 131 then respectively passes through the red filters 141, green filters 142 and blue filters 143, and is converted into red light, green light and blue light. As shown in FIG. 6, a full color display panel is obtained.

In the embodiment, the white light emitted from the organic light-emitting area 12 are mixed, scattered, and excited by the fluorescent material and/or the phosphorescent material. Thus, the luminescent efficiency can be increased, and the purity of the white light emitted from the organic light-emitting area 12 can be improved. Therefore, the white light with uniform and broadband radiation spectrum can be obtained, and satisfy the demands of full color displays.

Fourth Embodiment

With reference to FIG. 7, a color tunable panel of an organic electroluminescent display 2 according to the fourth embodiment of the invention comprises a transparent substrate 21, an organic light-emitting area 22 and a micro-lens array 23. In the embodiment, the transparent substrate 21 has a first surface 211 and a second surface 212, which are opposite to one another. The organic light-emitting area 22 is disposed on the first surface 211 of the transparent substrate 21 and comprises a plurality of pixels 221 for emitting short-wavelength light. The micro-lens array 23 is disposed on the second surface 212 of the transparent substrate 21 and comprises a plurality of micro-lenses 231, which are doped with a fluorescent material and/or a phosphorescent material and are disposed corresponding to the pixels 221, respectively. Herein, the short-wavelength light emitted from the pixels 221 of the organic light-emitting area 22 is ultraviolet light or blue light.

The features and functions of the transparent substrate 21, micro-lens array 23 and micro-lenses 231 are the same to those described in the first embodiment, so the detailed descriptions are omitted here for concise purpose.

As shown in FIG. 7, the organic light-emitting area 22 comprises a plurality of pixels 221 for emitting short-wavelength light. Each pixel 221 comprises, in sequence, a first electrode 2211, at least one organic functional layer 2212 and a second electrode 2213.

Wherein, the features and functions of the first electrode 2211 and second electrode 2213 of the embodiment are the same to the first electrode 1211 and second electrode 1213 of the first embodiment, so the detailed descriptions are omitted here for concise purpose.

In this case, the light emitted from the organic functional layer 2212 is short-wavelength light, such as ultraviolet light or blue light. In addition, the structures and functions of the organic functional layer 2212 are the same to the organic functional layer 1212 of the first embodiment, so the detailed descriptions are omitted here for concise purpose.

In the embodiment, the micro-lenses 231 may be doped with a fluorescent material and/or a phosphorescent material. As shown in FIG. 7, the fluorescent material can be red fluorescent powder, green fluorescent powder or blue fluorescent powder, and the phosphorescent material can be red phosphorescent powder, green phosphorescent powder or blue phosphorescent powder.

As mentioned above, the fluorescent material may include more than one organic dyes or more than one inorganic dyes. Herein, the red fluorescent powder may be an azo dye (organic dye) or Y₂O₂S:Eu³⁺, Bi³⁺ (inorganic dye). The green fluorescent powder may be a CuPc dye (organic dye) or SrGa₂O₄:Eu²⁺ (inorganic dye). The blue fluorescent powder may be a cyanine dye (organic dye) or SrGa₂S₄:Eu²⁺ (inorganic dye). In this embodiment, the fluorescent material may be nano sized powder.

In addition, the phosphorescent material may include more than one organic dye or more than one inorganic dye. In the embodiment, the red phosphorescent powder may be 2,3,7,8,12,13,17,18-octaethyl-12H,23H-porphine platinum(II) [PtOEP] or Tris-(4,4,4-trifluoro-1-(2-thienyl)-1,3-butanediono)-1,10-phenanthroline europium(III) [Eu(TTA)3phen]. The green phosphorescent powder may be Bis(2-phenyl-pyridinato-N,C2)iridium(acetylacetone) [ppy2Ir(acac)] or Iridium(III)bis(tolypyridine)salicyclidene [tpyIrsd]. The blue phosphorescent powder may be Iridium-bis(4,6-di-fluorophenyl-pyridinato-N,C2)-picolinate [Firpic] or Bis[(4,6-difluorophenyl-pyridinato-N,C2)iridium(acetylacetone) [Fir(acac)]. In this embodiment, the phosphorescent material may be nano sized powder.

Referring to FIG. 7, the color tunable panel 2 further comprises a plurality of filters 24 disposed on the micro-lenses 231. In the current embodiment, the filters 24 comprise at least one red filter 241, at least one green filter 242 and at least one blue filter 243.

In the embodiment, the short-wavelength light emitted from the organic light-emitting area 22 passes the micro-lens doped with red fluorescent powder and/or red phosphorescent powder, the micro-lens doped with green fluorescent powder and/or green phosphorescent powder, and the micro-lens doped with blue fluorescent powder and/or blue phosphorescent powder, respectively, so as to generate red light, green light and blue light. The generated red light, green light and blue light then respectively pass through the red filter 241, the green filter 242 and the blue filter 243 to generate the red light, green light and blue light of high purity. As shown in FIG. 7, the full color display panel can be obtained.

Furthermore, as shown in FIG. 7, the color tunable panel 2 of the embodiment may further comprise a pixel defining layer 25, a separating layer 26, a driving circuit (not shown) and an encapsulating unit 27. The features and functions of these elements are the same to those described in the first embodiment, so the detailed descriptions are omitted here for concise purpose.

In addition, a medium layer (not shown) is further disposed between the micro-lens array 23 and the second surface 212 of the transparent substrate 21. The micro-lenses 231 doped with the fluorescent material and/or the phosphorescent material is formed on the medium layer.

In addition, as shown in FIG. 7, the color tunable panel 2 of the embodiment may further comprise an isolating layer 28, which is disposed on the second surface 212 of the transparent substrate 21 for isolating the micro-lenses 231. This configuration can control the moving direction of the emitted light.

Fifth Embodiment

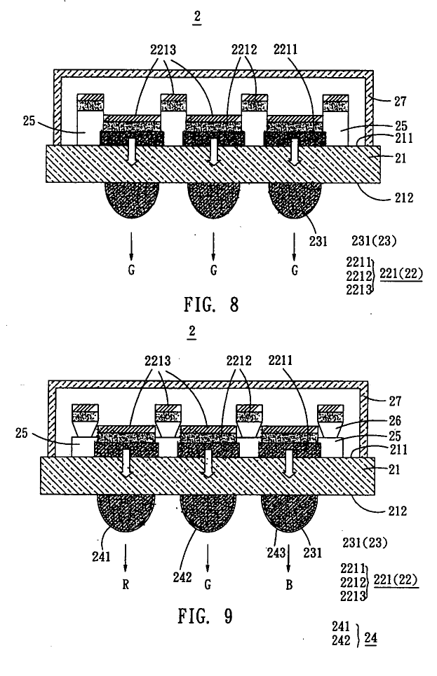

With reference to FIG. 8, the micro-lenses 231 are doped with a fluorescent material and/or a phosphorescent material. Wherein, the fluorescent material is green fluorescent powder and the phosphorescent material is green phosphorescent powder. In the fifth embodiment, the short-wavelength light emitted from the organic light-emitting area 22 passes through the micro-lenses 231 doped with the green fluorescent powder and/or green phosphorescent powder, so as to generate green light. Herein, the color tunable panel 2 is a green light display panel.

In this embodiment, the color tunable panel 2 may also comprise a plurality of filters. Herein, the filters are green filters (not shown).

Of course, the fluorescent material can be red fluorescent powder, the phosphorescent material can be red phosphorescent powder, and the filters can be red filters. Herein, the color tunable panel 2 is a red light display panel (not shown).

Of course, the fluorescent material can be blue fluorescent powder, the phosphorescent material can be blue phosphorescent powder, and the filters can be blue filters. Herein, the color tunable panel 2 is a blue light display panel (not shown).

Moreover, the fluorescent material and/or the phosphorescent material can be the fluorescent material and/or the phosphorescent material for emitting other monochromatic light, so as to manufacture the display panel with other monochromatic light.

Sixth Embodiment

With reference to FIG. 9, the fluorescent material can be the mixture of red fluorescent powder, green fluorescent powder and blue fluorescent powder, and the phosphorescent material can be the mixture of red phosphorescent powder, green phosphorescent powder and blue phosphorescent powder.

In the embodiment, the short-wavelength light emitted from the organic light-emitting area 22 passes through the micro-lenses 231 doped with the mixture of the red fluorescent powder, green fluorescent powder and blue fluorescent powder, and/or the mixture of the red phosphorescent powder, green phosphorescent powder and blue phosphorescent powder so as to generate white light. Herein, the color tunable panel 2 is a white light display panel (not shown).

In this embodiment, the color tunable panel 2 may also comprise a plurality of filters 24. Herein, the filters 24 are red filters 241, green filters 242 and blue filters 243. The broadband spectrum white light formed by the micro-lenses 231 then respectively passes through the red filters 241, green filters 242 and blue filters 243, and is converted into red light, green light and blue light. As shown in FIG. 9, a full color display panel is obtained.

In the embodiment, the short-wavelength light, such as ultraviolet light or blue light, emitted from the organic light-emitting area 22 are converted into white light according to the micro-lenses 231 doped with the mixture of red fluorescent powder, green fluorescent powder and blue fluorescent powder, and/or the mixture of red phosphorescent powder, green phosphorescent powder and blue phosphorescent powder. Thus, the luminescent efficiency of the organic light-emitting area 22 can be increased. Therefore, the white light with uniform and broadband radiation spectrum can be obtained, and satisfy the demands of full color displays.

Of course, the fluorescent material of the embodiment comprises at least two fluorescent powders with complementary colors, and the phosphorescent material comprises at least two phosphorescent powders with complementary colors. For example, the fluorescent material can be the mixture of orange fluorescent powder and blue fluorescent powder, and the phosphorescent material can be the mixture of orange phosphorescent powder and blue phosphorescent powder so as to generate white light. Similarly, the red filters 241, the green filters 242 and blue filters 243 can be used to manufacture the full color display panel (not shown).

Seventh Embodiment

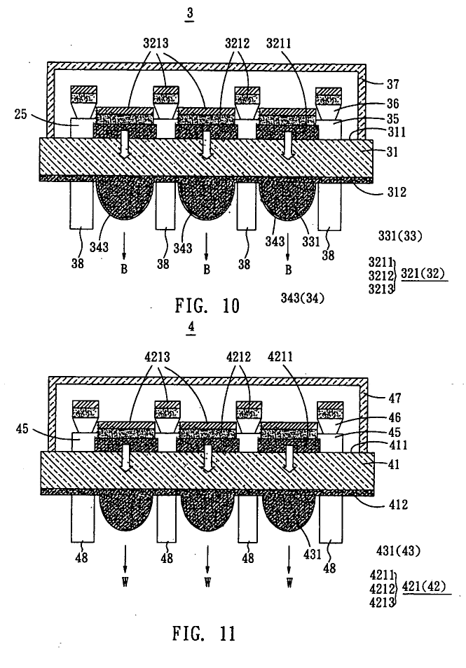

With reference to FIG. 10, a color tunable panel of an organic electroluminescent display 3 according to the seventh embodiment of the invention comprises a transparent substrate 31, an organic light-emitting area 32 and a film of a micro-lens array 33. In the embodiment, the transparent substrate 31 has a first surface 311 and a second surface 312, which are opposite to one another. The organic light-emitting area 32 is disposed on the first surface 311 of the transparent substrate 31 and comprises a plurality of pixels 321 for emitting white light. The film of a micro-lens array 33 is disposed on the second surface 312 of the transparent substrate 31 and comprises a plurality of micro-lenses 331, which are doped with a fluorescent material and/or a phosphorescent material.

The features and functions of the transparent substrate 31 and organic light-emitting area 32 are the same to the transparent substrate 11 and organic light-emitting area 12 described in the first embodiment, so the detailed descriptions are omitted here for concise purpose.

As shown in FIG. 10, the film of a micro-lens array 33 is disposed on the second surface 312 of the transparent substrate 31. Herein, the film of a micro-lens array 33 can be made by ejection modeling or thermal-pressing formation.

In the embodiment, the film of a micro-lens array 33 is doped with a fluorescent material and/or a phosphorescent material and comprises a plurality of micro-lenses 331. The fluorescent material is at least one selected from red fluorescent powder, green fluorescent powder and blue fluorescent powder, and the phosphorescent material is at least one selected from red phosphorescent powder, green phosphorescent powder and blue phosphorescent powder. The features and functions of the fluorescent material and the phosphorescent material are the same to those of the first, second and third embodiments, so the detailed descriptions are omitted here for concise purpose.

With reference to FIG. 10, the film of a micro-lens array 33 is doped with a fluorescent material and/or a phosphorescent material. In the embodiment, the white light emitted from the organic light-emitting area 32 passes through the film of a micro-lens array 33 doped with the blue fluorescent powder and/or blue phosphorescent powder, so as to generate blue light. Herein, the color tunable panel 3 is a blue light display panel.

In this embodiment, the color tunable panel 3 may also comprise a plurality of filters 34. Herein, the filters 34 are blue filters 343.

Moreover, the fluorescent material and/or the phosphorescent material can be the fluorescent material and/or the phosphorescent material for emitting other monochromatic light, so as to manufacture the display panel with other monochromatic light.

The features and functions of the micro-lenses 331 are the same to the micro-lenses 131 of the first embodiment, so the detailed descriptions are omitted here for concise purpose.

Furthermore, as shown in FIG. 10, the color tunable panel 3 of the embodiment may further comprise a pixel defining layer 35, a separating layer 36, a driving circuit (not shown), an encapsulating unit 37 and an isolating layer 38. The features and functions of these elements are the same to those described in the first embodiment, so the detailed descriptions are omitted here for concise purpose.

Eighth Embodiment

With reference to FIG. 11, a color tunable panel of an organic electroluminescent display 4 according to the eighth embodiment of the invention comprises a transparent substrate 41, an organic light-emitting area 42 and a film of a micro-lens array 43. In the embodiment, the transparent substrate 41 has a first surface 411 and a second surface 412, which are opposite to one another. The organic light-emitting area 42 is disposed on the first surface 411 of the transparent substrate 41 and comprises a plurality of pixels for emitting short-wavelength light. The film of a micro-lens array 43 is disposed on the second surface 412 of the transparent substrate 41 and comprises a plurality of micro-lenses 431, which are doped with a fluorescent material and/or a phosphorescent material.

The features and functions of the transparent substrate 41 and organic light-emitting area 42 are the same to the transparent substrate 21 and organic light-emitting area 22 described in the fourth embodiment, so the detailed descriptions are omitted here for concise purpose.

In addition, the features and functions of the film of a micro-lens array 43 are the same to the micro-lens array film 33 described in the seventh embodiment, so the detailed descriptions are omitted here for concise purpose.

With reference to FIG. 11, the fluorescent material can be the mixture of red fluorescent powder, green fluorescent powder and blue fluorescent powder, and the phosphorescent material can be the mixture of red phosphorescent powder, green phosphorescent powder and blue phosphorescent powder.

In the present embodiment, the short-wavelength light emitted from the organic light-emitting area 42 passes through the micro-lenses 431 doped with the mixture of red fluorescent powder, green fluorescent powder and blue fluorescent powder and/or the mixture of red phosphorescent powder, green phosphorescent powder and blue phosphorescent powder, so as to generate white light. Herein, the color tunable panel 4 is a white light display panel.

In this embodiment, the color tunable panel 4 may also comprise a plurality of filters (not shown).

Of course, the fluorescent material of the embodiment comprises at least two fluorescent powders with complementary colors, and the phosphorescent material comprises at least two phosphorescent powders with complementary colors. For example, the fluorescent material can be the mixture of orange fluorescent powder and blue fluorescent powder, and the phosphorescent material can be the mixture of orange phosphorescent powder and blue phosphorescent powder so as to generate white light.

Furthermore, as shown in FIG. 11, the color tunable panel 4 of the embodiment may further comprise a pixel defining layer 45, a separating layer 46, a driving circuit (not shown), an encapsulating unit 47 and an isolating layer 48. The features and functions of these elements are the same to those described in the first embodiment, so the detailed descriptions are omitted here for concise purpose.

As mentioned above, the color tunable panel of the organic electroluminescent display comprises the micro-lenses doped with the fluorescent materials and/or the phosphorescent materials, the micro-lens array or the film of a micro-lens array, which are disposed on the second surface of the transparent substrate. Comparing with the conventional art, the micro-lenses doped with the fluorescent materials and/or the phosphorescent materials, the micro-lens array or the film of a micro-lens array can convert the white light or short-wavelength light, such as UV light or blue light, emitted from the organic light-emitting area into monochromatic light of various colors, combination of monochromatic lights, or broadband spectrum white light. Thus, the color tunable panel for emitting monochromatic light, combination of monochromatic lights, white light or color light can be obtained. Furthermore, the luminescent efficiency of the panel can be increased by the excitation of short-wavelength light to the fluorescent materials and/or the phosphorescent materials, so the decay of luminescent efficiency caused by the absorption of the color conversion films and filters in the color conversion medium technology can be compensated efficiently. Moreover, the invention comprises color filters to purify each color light or to filter out the wanted color light, so that the application of the display on the various colors can be broadened. In addition, the micro-lenses doped with the fluorescent materials and/or the phosphorescent materials and the film of a micro-lens array can improve the color purity of the white light emitted from the organic light-emitting area. This can provide a uniform and broadband radiation spectrum to satisfy the application of full color displays. The special shape of the micro-lenses can decrease the possibility that the light is restricted inside the panel, so as to increase the external quantum efficiency of the organic electroluminescent display. The micro-lenses can also protect the substrate from scratch. The micro-lenses can be manufactured by screen printing, ink-jet printing or semiconductor processes and the film of a micro-lens array can be manufactured by ejection modeling or thermal-pressing formation, which are simple, convenient operation, and low manufacturing cost. Thus, the invention is suitable for mass production. Furthermore, the invention comprises an isolating layer for controlling the moving direction of the light emitted from the micro-lenses, so that the light scattering and interfering can be reduced. In brief, micro-lenses doped with fluorescent material and/or phosphorescent material and the film of a micro-lens array of the invention possesses the function of modulating colors emitted form the panel, pixel protection. Also, the micro-lenses with high refraction can compensate the luminescent efficiency lose after filtering, and further increase luminescent efficiency. Therefore, the display of the invention can provide a uniform spectrum, increase the aspect ratio of the pixels when the panel emits light, and increase the lifetime thereof. In addition, when the color tunable panel of the organic electroluminescent display can display full color, the conventional selective deposition processes for forming the three primary color pixels can be saved. Thus, the resolution of the panel may not restrict to the fine pattern of the mask, and the manufacturing yield can be enhanced. Therefore, the invention can apply the present developed fluorescent and/or phosphorescent materials and color filter technology in the panel, so as to speed the commercialization of color tunable panel of the organic electroluminescent display.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A color tunable panel of an organic electroluminescent display, at least comprising:
a transparent substrate, which has a first surface and a second surface opposite to the first surface;
an organic light-emitting area, which is disposed over the first surface of the transparent substrate and comprises a plurality of pixels for emitting white light or short-wavelength light; and
a micro-lens array, which is disposed over the second surface of the transparent substrate and comprises a plurality of micro-lenses, wherein the micro-lenses are doped with a fluorescent material and/or a phosphorescent material.

2. The color tunable panel of claim 1, wherein the pixel sequentially comprises a first electrode, at least one organic functional layer and a second electrode.

3. The color tunable panel of claim 2, further comprising a pixel-defining layer, which is disposed on the first electrode and/or the transparent substrate for defining the pixels of the organic light-emitting area.

4. The color tunable panel of claim 3, further comprising a separating layer, which is disposed on the pixel-defining layer.

5. The color tunable panel of claim 2, wherein the first electrode comprises conductive metal oxide.

6. The color tunable panel of claim 2, wherein the second electrode is made of at least one material selected from the group consisting of aluminum, calcium, magnesium, indium, zinc, manganese, silver, gold and magnesium alloy.

7. The color tunable panel of claim 1, wherein the micro-lenses comprise curved surfaces.

8. The color tunable panel of claim 1, wherein the micro-lenses comprise a transparent medium doped with the fluorescent material and/or the phosphorescent material.

9. The color tunable panel of claim 8, wherein the transparent medium is at least one selected from the group consisting of polymethyl methacrylate (PMMA), tetrafluoroethylene resin, silicon resin and silicon oxide (SiOₓ).

10. The color tunable panel of claim 8, wherein the transparent medium comprises a photo-cured material.

11. The color tunable panel of claim 8, wherein the transparent medium is capable of adhesive and/or waterproof.

12. The color tunable panel of claim 1, wherein the fluorescent material is at least one selected from the group consisting of red fluorescent powder, green fluorescent powder and blue fluorescent powder, and the phosphorescent material is at least one selected from the group consisting of red phosphorescent powder, green phosphorescent powder and blue phosphorescent powder.

13. The color tunable panel of claim 1, wherein the fluorescent material and/or the phosphorescent material comprise a nano sized fluorescent powder and/or a nano sized phosphorescent powder.

14. The color tunable panel of claim 1, further comprising:
a medium layer, which is disposed between the second surface of the transparent substrate and the micro-lens array.

15. The color tunable panel of claim 1, further comprising:
a plurality of filters, which are disposed on the micro-lenses.

16. The color tunable panel of claim 15, wherein the filters are at least one selected form the group consisting of red filters, blue filters and green filters.

17. The color tunable panel of claim 1, wherein the micro-lenses are corresponding to the pixels, respectively.

18. The color tunable panel of claim 1, further comprising:
an isolating layer, which is disposed on the second surface of the transparent substrate for isolating the micro-lenses.

19. A color tunable panel of an organic electroluminescent display, at least comprising:
a transparent substrate, which has a first surface and a second surface opposite to the first surface;
an organic light-emitting area, which is disposed over the first surface of the transparent substrate and comprises a plurality of pixels for emitting white light or short-wavelength light; and
a film of a micro-lens array, which is disposed over the second surface of the transparent substrate and comprises a plurality of micro-lenses, wherein the micro-lenses are doped with a fluorescent material and/or a phosphorescent material.

20. The color tunable panel of claim 19, further comprising:
an isolating layer, which is disposed on the second surface of the transparent substrate for isolating the micro-lenses.
